(19) United States
(12) Patent Application Publication
(10) Pub. No.: US 2021/0016253 A1
(43) Pub. Date: Jan. 21, 2021

(54) HIGHLY DISPERSED ULTRA-SMALL SIZE CARBON-SUPPORTED NOBLE METAL CATALYST AND PREPARATION METHOD THEREOF

(71) Applicants: Xi'an Jiaotong University, Xi'an (CN); Shaanxi Quantong Industrial Group Co., Ltd., Xi'an (CN)

(72) Inventors: Shengchun Yang, Xi'an (CN); Saisai Gao, Xi'an (CN); Bin Wang, Xi'an (CN)

(21) Appl. No.: 16/872,948

(22) Filed: May 12, 2020

(30) Foreign Application Priority Data
Jul. 17, 2019 (CN) 201910644964.2

(51) Int. Cl. B01J 23/52; B01J 37/04; B01J 35/02; B01J 37/06; B01J 37/00

(52) U.S. Cl. CPC B01J 23/52; B01J 37/04; B01J 21/185; B01J 37/06; B01J 37/0045; B01J 35/023

(57) ABSTRACT

The invention provides a highly dispersed ultra-small size carbon-supported noble metal catalyst and a preparation method thereof. The preparation method comprises: Step S1, mixing a carbon material with a hydrogenated borophene dispersion, wherein in a mixed solution, a mass ratio of the carbon material to the hydrogenated borophene is 1:0.01-1, and then dispersing the activated carbon in the mixed solution sufficiently and uniformly to obtain a uniform carbon material-supported hydrogenated borophene dispersion; Step S2, adding an aqueous solution of a noble metal precursor to the uniform carbon material-supported hydrogenated borophene dispersion according to a mass ratio of the carbon material to the noble metal of 1:0.001-0.5, and fully stirring to obtain a suspension; and Step S3, filtering the suspension, and after treatment, to obtain the highly dispersed ultra-small size carbon-supported noble metal catalyst.

### TECHNICAL FIELD

The invention relates to the field of preparation of noble metal catalysts, and in particular, to a preparation method of a highly dispersed ultra-small size carbon-supported noble metal catalyst, and a highly dispersed ultra-small size carbon-supported noble metal catalyst.

### BACKGROUND

Noble metal catalysts have been widely used as catalysts for electrocatalytic hydrogen evolution reaction, electrode catalysts for fuel cells, and catalysts for reactions such as hydrodehydrogenation. At the same time, noble metal catalysts are currently the most mature, most commonly used and best performing catalysts. However, the reserves of noble metals (platinum, palladium, gold, iridium, rhodium, etc.) are limited and the price of nobel metals is expensive, which make the cost of noble metal catalysts high, especially limiting the widespread application of fuel cells. At present, mass-produced platinum carbon catalysts are usually prepared by an immersion reduction method, and have a disadvantage in that platinum particles have a large diameter. Therefore, there is an urgent need to explore a catalyst preparation method which can improve the utilization rate of noble metals and reduce the production cost.

### SUMMARY

The present invention provides a highly dispersed ultra-small size carbon-supported noble metal catalyst and a preparation method thereof to overcome the above technical problems.

In order to solve the above problems, the present invention discloses a method for preparing a highly dispersed ultra-small size carbon-supported noble metal catalyst, the method comprises:

Step S1: mixing a carbon material with a hydrogenated borophene dispersion, wherein, in a mixed solution, a mass ratio of the carbon material to the hydrogenated borophene is 1:0.01-1; then dispersing the activated carbon in the mixed solution sufficiently and uniformly to obtain a uniform carbon material-supported hydrogenated borophene dispersion;

Step S2: adding an aqueous solution of a noble metal precursor to the uniform carbon material-supported hydrogenated borophene dispersion according to a mass ratio of the carbon material to the noble metal of 1:0.001-0.5, and fully stirring to obtain a suspension of an ultra-small size carbon material-supported noble metal particle catalyst;

Step S3: filtering the suspension to obtain a catalyst powder, and then thoroughly washing the catalyst powder to remove soluble impurities, and finally filtering and drying the powder after washing to obtain the highly dispersed ultra-small size carbon-supported noble metal catalyst.

Optionally, the carbon material is one or more selected from the group consisting of carbon black, activated carbon, graphene, graphene oxide, graphdiyne, carbon nanotubes, carbon nanofibers, carbon nanospheres, natural graphite and porous carbon.

Optionally, a solvent used in the hydrogenated borophene dispersion is one or more selected from the group consisting of methanol, ethanol, acetone, tetrahydrofuran, and N, N-dimethylformamide.

Optionally, the hydrogenated borophene dispersion has a mass concentration of 0.01-20 mg/mL.

Preferably, the step of dispersing the activated carbon in the mixed solution sufficiently and uniformly comprises:

using magnetic stirring and ultrasonic dispersion to disperse the activated carbon in the mixed solution sufficiently and uniformly.

Optionally, the aqueous solution of the noble metal precursor is a soluble noble metal acid solution or a soluble noble metal salt solution.

Optionally, the soluble noble metal acid solution is one or more selected from the group consisting of chloroplatinic acid, chloroauric acid, chloropalladic acid, potassium hexachlororuthenate, chloroiridic acid and chlororhodic acid solution.

Optionally, a concentration of the aqueous solution of the noble metal precursor is 1-200 mmol/L.

Based on the same inventive concept, corresponding to a method for preparing a catalyst according to the present invention, the present invention also discloses a highly dispersed ultra-small size carbon-supported noble metal catalyst, the highly dispersed ultra-small size carbon-supported noble metal catalyst is prepared by the method according to any one of claims 1-8, in the highly dispersed ultra-small size carbon-supported noble metal catalyst, the noble metal particles have a diameter of 0.5-5 nm.

Compared with the prior art, the present invention includes the following advantages:

The present invention does not require the addition of a surfactant or a reducing agent in the preparation process, does not require high-temperature reduction treatment, is cost-effective and environmentally friendly, the hydrogenated borophene serves as a “reducing agent” and “stabilizer”, and the noble metal particles have a clean surface and high catalytic activity; the preparation method is simple, the process is simplified, the equipment requirements are low, and the industrial production is easy to realize;

The catalysts prepared by the present invention have a noble metal particle diameter of 0.5-5 nm, the particles are uniformly dispersed and uniform in size with no agglomeration, which make significant progress compared with the prior arts, and there are great market demands and broad application prospects in the fields of fuel cell, petrochemical, biomedicine and environmental protection.

### BRIEF DESCRIPTION OF THE DRAWINGS

FIG. 1 is a flow chart of steps for preparing a highly dispersed ultra-small size carbon-supported noble metal catalyst according to the present invention;

FIG. 2 is a transmission electron micrograph of the activated carbon of Embodiment 1 of the present invention;

FIG. 3 is a transmission electron micrograph of the hydrogenated borophene of Embodiment 1 of the present invention;

FIG. 4 is a transmission electron micrograph of an ultra-small size activated carbon-supported platinum nanoparticle catalyst prepared in Embodiment 1 of the present invention;

FIG. 5 is a transmission electron micrograph of an ultra-small size activated carbon-supported size gold nanoparticle catalyst prepared in Embodiment 2 of the present invention;

FIG. 6 is a transmission electron micrograph of an ultra-small size activated carbon-supported palladium nanoparticle catalyst prepared in Embodiment 3 of the present invention;

FIG. 7 is a transmission electron micrograph of an ultra-small size activated carbon-supported ruthenium nanoparticle catalyst prepared in Embodiment 4 of the present invention;

FIG. 8 is a transmission electron micrograph of an ultra-small size activated carbon-supported iridium nanoparticle catalyst prepared in Embodiment 5 of the present invention;

FIG. 9 is a transmission electron micrograph of an ultra-small size activated carbon-supported rhodium nanoparticle catalyst prepared in Embodiment 6 of the present invention.

### DESCRIPTION OF THE EMBODIMENTS

The present invention will be further described in detail with reference to the accompanying drawings and specific embodiments in order to make the above-mentioned objects, features, and advantages of the present invention more comprehensible.

Reducing particle size and improving the uniformity of noble metal particles is one of the effective means to increase the specific surface area of noble metal catalysts, increase the utilization of noble metals, and increase surface active sites. However, while reducing the particle size, in order to prevent agglomeration of ultra-small size particles and improve the stability of the noble metal particles, the existing preparation method (U.S. Pat. No. 7,053,021B1) usually adds organic solvents such as PVP, CTAB/CTAC, oleamide/oleic acid or 1,2-dihydroxyhexadecane as a stabilizer and a reducing agent, but these organic solvents are coated on the surface of the noble metal particles to be difficult to remove, thereby reducing the catalytic activity; in addition, these organic solvents are generally toxic and unfriendly to the environment, and it is not conducive to reducing production costs.

In recent years, with the development of new low-dimensional materials (graphene, carbon nanotubes, molybdenum disulfide, black phosphorus, etc.), the inventors discovered that loading noble metal particles onto the surface of a low-dimensional material having a large specific surface area can effectively increase the dispersion of the noble metal particles, thereby increasing the specific surface area of the noble metal catalyst and effectively preventing agglomeration of the particles.

Therefore, the inventors first proposed a scheme for preparing a noble metal particle catalyst using borophene and/or its derivative materials. Specifically, the present invention uses hydrogenated borophene to prepare a noble metal particle catalyst. Borophene is a two-dimensional material with single atom thickness composed of boron element, which has superior electrical, mechanical and thermal properties. The present invention applies the hydrogenated borophene in the preparation process of the noble metal particle catalyst, the covalent B—H bond on the surface of the hydrogenated borophene is broken to generate hydrogen gas, and then the noble metal ion is reduced in situ, and the formed noble metal atom or cluster is produced a covalent effect with B═B conjugated system, which in turn attaches to the surface of the hydrogenated borophene and further grows into noble metal nanoparticles. In this process, due to the high density of surface reduction sites of the hydrogenated borophene, a high noble metal nucleation rate is caused, thereby promoting monodispersity of the particle size distribution. In addition, due to the templating action of the hydrogenated borophene, the agglomeration of the particles is effectively prevented. The use of hydrogenated borophene as a “reducing agent” and “stabilizer” makes it unnecessary to add a surfactant or a reducing agent in the preparation process, it does not require high-temperature reduction treatment, and the process is cost-effective and environmentally friendly; in addition, since no surfactant is used, the surface of the noble metal particles is coated with no organic substances such as surfactants, the surface is clean and the catalytic activity is high.

Next, a scheme for preparing a noble metal particle catalyst using hydrogenated borophene of the present invention will be described in detail.

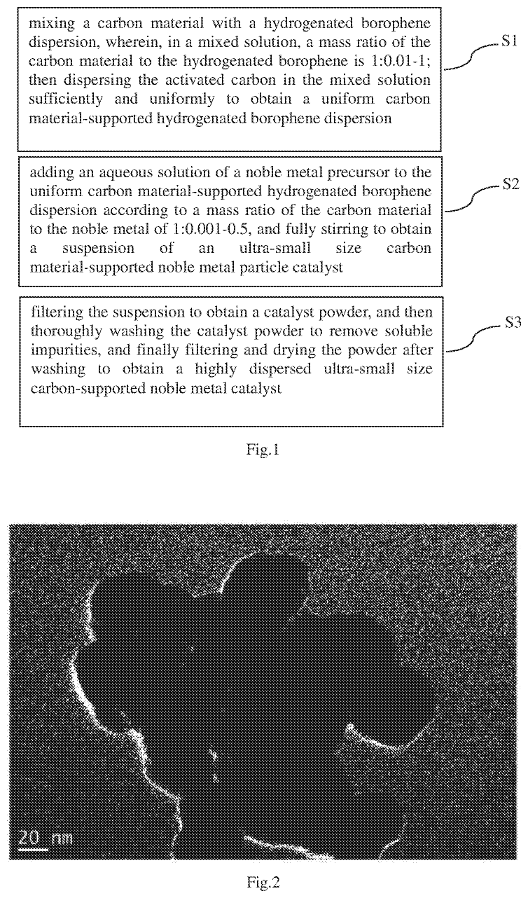

Referring to FIG. 1, a flow chart showing the steps of a method for preparing a highly dispersed ultra-small size carbon-supported noble metal catalyst according to the present invention is shown, and the method comprises:

Step S1: mixing a carbon material with a hydrogenated borophene dispersion, wherein, in a mixed solution, a mass ratio of the carbon material to the borophane is 1:0.01-1; then dispersing the activated carbon in the mixed solution sufficiently and uniformly to obtain a uniform carbon material-supported hydrogenated borophene dispersion;

In the present invention, the above carbon material is one or more selected from the group consisting of carbon black, activated carbon, graphene, graphene oxide, graphdiyne, carbon nanotubes, carbon nanofibers, carbon nanospheres, natural graphite and porous carbon.

A solvent used in the hydrogenated borophene dispersion is one or more selected from the group consisting of methanol, ethanol, acetone, tetrahydrofuran, and N, N-dimethylformamide. Wherein, a mass concentration of the hydrogenated borophene dispersion is preferably 0.01-20 mg/mL.

For the above steps, in a preferred embodiment of the present invention, the step of dispersing the activated carbon in the mixed solution sufficiently and uniformly comprises:

using magnetic stirring and ultrasonic dispersion to disperse the activated carbon in the mixed solution sufficiently and uniformly.

Step S2: adding an aqueous solution of a noble metal precursor to the uniform carbon material-supported hydrogenated borophene dispersion according to a mass ratio of the carbon material to the noble metal of 1:0.001-0.5, and fully stirring to obtain a suspension of an ultra-small size carbon material-supported noble metal particle catalyst;

In the present invention, the aqueous solution of the noble metal precursor is a soluble noble metal acid solution or a soluble noble metal salt solution. Preferably, the soluble noble metal acid solution is one or more selected from the group consisting of chloroplatinic acid, chloroauric acid, chloropalladic acid, potassium hexachlororuthenate, chloroiridic acid and chlororhodic acid solution. Wherein, a concentration of the aqueous solution of the noble metal precursor is preferably 1-200 mmol/L.

Step S3: filtering the suspension to obtain a catalyst powder, and then thoroughly washing the catalyst powder to remove soluble impurities, and finally filtering and drying the powder after washing to obtain the highly dispersed ultra-small size carbon-supported noble metal catalyst.

It is known from Steps S1 to S3 that the present invention uses a hydrogenated borophene to act as a “reducing agent” and a “stabilizer” without adding a surfactant or a reducing agent in the preparation process, it does not require high-temperature reduction treatment, is cost-effective and environmentally friendly, and the noble metal particles have a clean surface and high catalytic activity; the preparation method is simple, the equipment requirements are low, and the industrial production is easy to realize.

Based on the same inventive concept, the present invention also discloses a highly dispersed ultra-small size carbon-supported noble metal catalyst, the highly dispersed ultra-small size carbon-supported noble metal catalyst is prepared by the method of FIG. 1, in the highly dispersed ultra-small size carbon-supported noble metal catalyst, the noble metal particles have a diameter of 0.5-5 nm.

The catalysts obtained by the present invention have a noble metal particle diameter of 0.5-5 nm, and the particles are uniformly dispersed and uniform in size with no agglomeration, there are great market demands and broad application prospects in the fields of fuel cell, petrochemical, biomedicine and environmental protection.

Next, the technical solutions and technical effects of the present invention will be further described with reference to specific embodiments.

### Embodiment 1

Experiment with the noble metal “platinum”.

First, weighed 25 mg of activated carbon, and mixed the activated carbon with 1.25 mL of a methanol dispersion of hydrogenated borophene, wherein, a mass concentration of the methanol dispersion of hydrogenated borophene was 20 mg/mL, a mass ratio of the activated carbon to the hydrogenated borophene e was 1:1; then, the activated carbon was uniformly dispersed by magnetic stirring and ultrasonic dispersion to obtain a uniform activated carbon-supported hydrogenated borophene dispersion. Next, added 3150 of an aqueous solution of potassium chloroplatinate to the above dispersion according to a mass ratio of the activated carbon to the noble metal of 1:0.5, wherein a concentration of the aqueous solution of potassium chloroplatinate was 200 mM (1 mM=1 mmol/L, in the following embodiments, mM was used as the concentration unit of the aqueous solution of noble metals), and the mixture was sufficiently stirred at room temperature to obtain a suspension of an ultra-small size activated carbon-supported platinum nanoparticle catalyst. The suspension was filtered to obtain a solid precipitate, which was thoroughly washed with water and ethanol to remove soluble impurities, and the solid precipitate after washing was sufficiently dried, and finally the obtained product was a highly dispersed ultra-small size carbon-supported platinum particle catalyst.

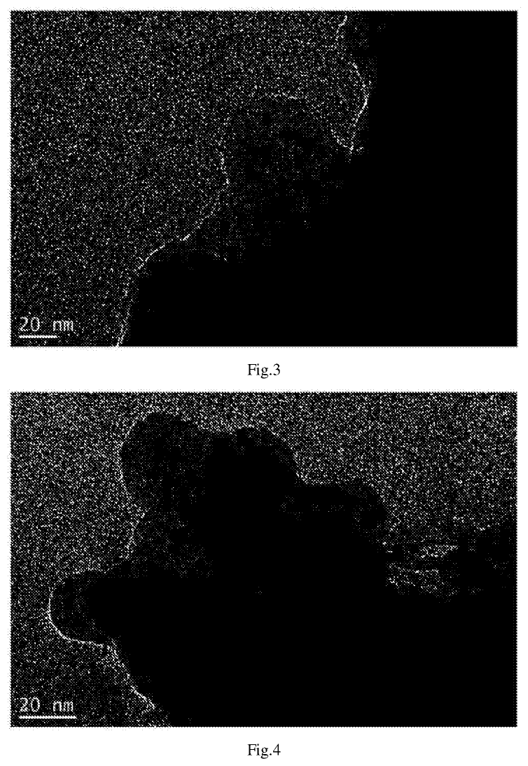

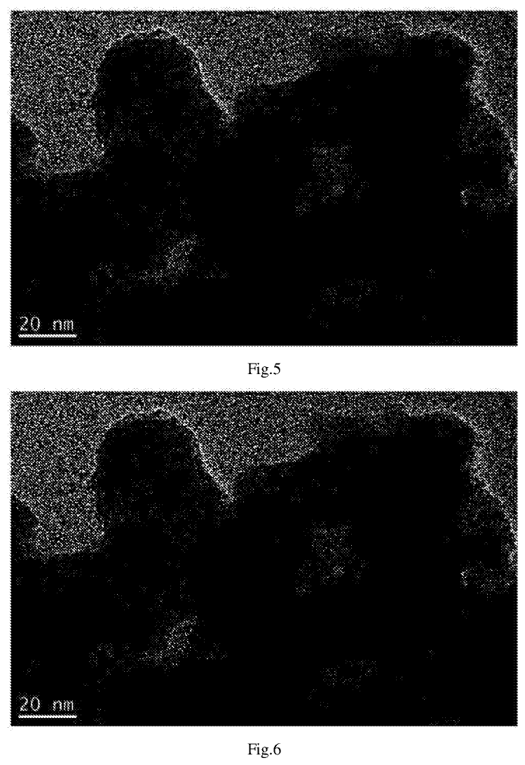

In the embodiment of the present invention, FIG. 2 is a transmission electron micrograph of the activated carbon, it can be seen that the activated carbon surface is smooth and unloaded; FIG. 3 is a transmission electron micrograph of hydrogenated borophene, and the lamellar film morphology of hydrogenated borophene can be seen; FIG. 4 is a transmission electron micrograph of an ultra-small size activated carbon-supported platinum nanoparticle catalyst prepared by using the present invention, with a scale of 20 nm, it can be seen that the platinum nanoparticles (average particle diameter of about 2.1 nm) are uniformly supported on the surface of the activated carbon, and the particle size is uniform and there is no agglomeration.

### Embodiment 2

Experiment with the noble metal “gold”.

First, weighed 25 mg of activated carbon, and mixed the activated carbon with 20 ml of an ethanol dispersion of hydrogenated borophene, a mass concentration of the ethanol dispersion of hydrogenated borophene was 0.25 mg/ml, wherein a mass ratio of the activated carbon to the hydrogenated borophene is 1:0.2; then, the activated carbon was uniformly dispersed by magnetic stirring and ultrasonic dispersion to obtain a uniform activated carbon-supported hydrogenated borophene dispersion. Next, 320 μl of an aqueous solution of chloroauric acid was added to the above dispersion according to a mass ratio of the activated carbon to the noble metal of 1:0.125, wherein the concentration of the aqueous solution of chloroauric acid was 100 mM, and the mixture was thoroughly stirred at room temperature to obtain a suspension of an ultra-small size activated carbon-supported gold nanoparticle catalyst. The suspension was filtered to obtain a solid precipitate, which was thoroughly washed with water and ethanol to remove soluble impurities, and the solid precipitate after washing was sufficiently dried, and finally the obtained product was a highly dispersed ultra-small size carbon-supported gold particle catalyst.

FIG. 5 is a transmission electron micrograph of an ultra-small size activated carbon-supported gold nanoparticle catalyst prepared by the present invention, with a scale of 20 nm, and it can be seen that the gold nanoparticles (average particle diameter of about 1.8 nm) are uniformly supported on the activated carbon surface, and there is no agglomeration. In the embodiment of the present invention, the transmission electron micrograph of the activated carbon and the transmission electron micrograph of the hydrogenated borophene are respectively referred to the FIG. 2 and FIG. 3.

### Embodiment 3

Experiment with the noble metal “palladium”.

First, weighed 25 mg of activated carbon, and mixed the activated carbon with 25 ml of a tetrahydrofuran dispersion of hydrogenated borophene, a mass concentration of the tetrahydrofuran dispersion of hydrogenated borophene was 0.01 mg/ml, wherein a mass ratio of the activated carbon to the hydrogenated borophene is 1:0.01; then, the activated carbon was uniformly dispersed by magnetic stirring and ultrasonic dispersion to obtain a uniform activated carbon-supported hydrogenated borophene dispersion. Next, 236 μl of an aqueous solution of potassium chloropalladate was added to the above dispersion according to a mass ratio of the activated carbon to the noble metal of 1:0.001, wherein a concentration of the aqueous solution of potassium chloropalladate was 1 mM, and the mixture was thoroughly stirred at room temperature to obtain a suspension of an ultra-small size activated carbon-supported palladium nanoparticle catalyst. The suspension was filtered to obtain a solid precipitate, which was thoroughly washed with water and ethanol to remove soluble impurities, and the solid precipitate after washing was sufficiently dried, and finally the obtained product was a highly dispersed ultra-small size carbon-supported palladium particle catalyst.

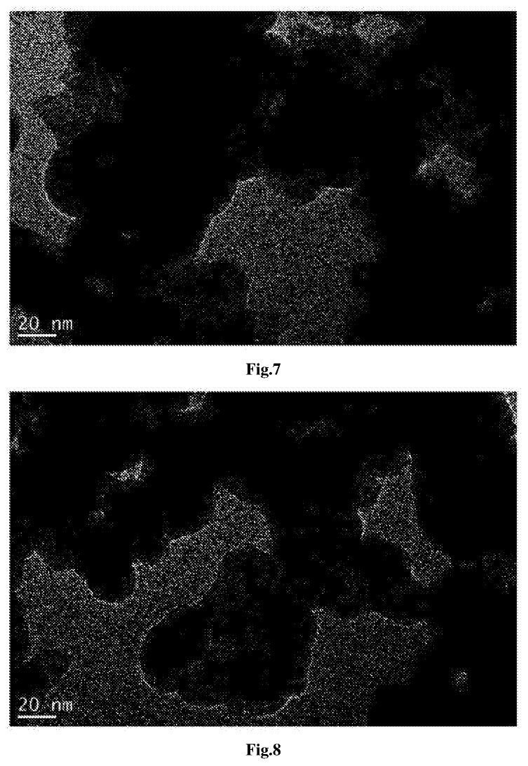

FIG. 6 is a transmission electron micrograph of an ultra-small size activated carbon-supported palladium nanoparticle catalyst prepared by the present invention, with a scale of 20 nm, and it can be seen that palladium nanoparticles (average particle diameter of about 1.3 nm) are uniformly supported on the surface of the activated carbon, and there is no agglomeration. In the embodiment of the present invention, the transmission electron micrograph of the activated carbon and the transmission electron micrograph of the hydrogenated borophene are respectively referred to the FIG. 2 and FIG. 3.

### Embodiment 4

Experiment with the noble metal “ruthenium”.

First, weighed 25 mg of activated carbon, and mixed the activated carbon with 10 ml of an acetone dispersion of hydrogenated borophene, a mass concentration of the acetone dispersion of hydrogenated borophene was 0.5 mg/ml, wherein a mass ratio of the activated carbon to the hydrogenated borophene was 1:0.2; then, the activated carbon was uniformly dispersed by magnetic stirring and ultrasonic dispersion to obtain a uniform activated carbon-supported hydrogenated borophene dispersion. Next, 320 μl of an aqueous solution of potassium hexachlororuthenate was added to the above dispersion according to a mass ratio of the activated carbon to the noble metal of 1:0.25, wherein a concentration of the aqueous solution of potassium hexachlororuthenate was 100 mM, and the mixture was thoroughly stirred at room temperature to obtain a suspension of an ultra-small size activated carbon-supported ruthenium nanoparticle catalyst. The suspension was filtered to obtain a solid precipitate, which was thoroughly washed with water and ethanol to remove soluble impurities, and the solid precipitate after washing was sufficiently dried, and finally the obtained product was a highly dispersed ultra-small size carbon-supported ruthenium particle catalyst.

FIG. 7 is a transmission electron micrograph of an ultra-small size activated carbon-supported ruthenium nanoparticle catalyst prepared by the present invention, with a scale of 20 nm, and it can be seen that the ruthenium nanoparticles (average particle diameter of about 1.5 nm) are uniformly supported on the activated carbon surface, and there is no agglomeration. In the embodiment of the present invention, the transmission electron micrograph of the activated carbon and the transmission electron micrograph of the hydrogenated borophene are respectively referred to the FIG. 2 and FIG. 3.

### Embodiment 5

Experiment with the noble metal “iridium”.

First, weighed 25 mg of activated carbon, and mixed the activated carbon with 10 ml of a methanol dispersion of hydrogenated borophene, a mass concentration of the methanol dispersion of hydrogenated borophene was 0.5 mg/ml, wherein a mass ratio of the activated carbon to the hydrogenated borophene was 1:0.2; then, the activated carbon was uniformly dispersed by magnetic stirring and ultrasonic dispersion to obtain a uniform activated carbon-supported hydrogenated borophene dispersion. Next, 320 μl of an aqueous solution of chloroiridic acid was added to the above dispersion according to a mass ratio of the activated carbon to the noble metal of 1:0.25, wherein a concentration of the aqueous solution of chloroiridic acid was 100 mM, and the mixture was thoroughly stirred at room temperature to obtain a suspension of an ultra-small size activated carbon-supported iridium nanoparticle catalyst. The suspension was filtered to obtain a solid precipitate, which was thoroughly washed with water and ethanol to remove soluble impurities, and the solid precipitate after washing was sufficiently dried, and finally the obtained product was a highly dispersed ultra-small size carbon-supported iridium particle catalyst.

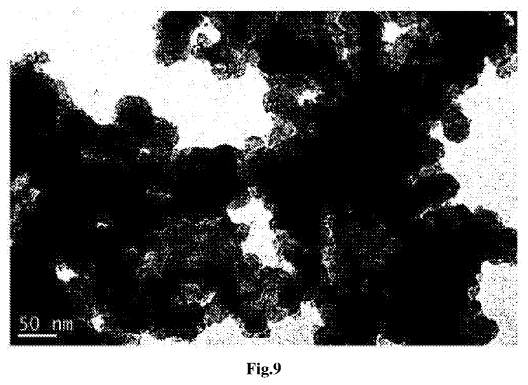

FIG. 8 is a transmission electron micrograph of an ultra-small size activated carbon-supported iridium nanoparticle catalyst prepared by the present invention, with a scale of 20 nm, and it can be seen that the iridium nanoparticles (average particle diameter of about 2 nm) are uniformly supported on the surface of the activated carbon, and there is no agglomeration. In the embodiment of the present invention, the transmission electron micrograph of the activated carbon and the transmission electron micrograph of the hydrogenated borophene are respectively referred to the FIG. 2 and FIG. 3.

### Embodiment 6

Experiment with the noble metal “rhodium”.

First, weighed 25 mg of activated carbon, and mixed the activated carbon with 10 ml of an acetone dispersion of hydrogenated borophene, a mass concentration of the acetone dispersion of hydrogenated borophene was 0.5 mg/ml, wherein a mass ratio of the activated carbon to the hydrogenated borophene was 1:0.2; then, the activated carbon was uniformly dispersed by magnetic stirring and ultrasonic dispersion to obtain a uniform activated carbon-supported hydrogenated borophene dispersion. Next, 200 μl of an aqueous solution of potassium hexachlororhodate was added to the above dispersion according to a mass ratio of the activated carbon to the noble metal of 1:0.08, wherein a concentration of the aqueous solution of potassium hexachlororhodate was 100 mM, and the mixture was thoroughly stirred at room temperature to obtain a suspension of an ultra-small size activated carbon-supported rhodium nanoparticle catalyst. The suspension was filtered to obtain a solid precipitate, which was thoroughly washed with water and ethanol to remove soluble impurities, and the solid precipitate after washing was sufficiently dried, and finally the obtained product was a highly dispersed ultra-small size carbon-supported rhodium particle catalyst.

FIG. 9 is a transmission electron micrograph of an ultra-small size activated carbon-supported rhodium nanoparticle catalyst prepared by the present invention, with a scale of 50 nm, and it can be seen that the rhodium nanoparticles (average particle diameter of about 2.8 nm) are uniformly supported on the activated carbon surface, and there is no agglomeration. In the embodiment of the present invention, the transmission electron micrograph of the activated carbon and the transmission electron micrograph of the hydrogenated borophene are respectively referred to the FIG. 2 and FIG. 3 of Embodiment 1.

In summary, the above-mentioned six embodiments fully demonstrate that the catalysts prepared according to the preparation method of the present invention have a noble metal particle diameter of 0.5-5 nm, the particles are uniformly dispersed and uniform in size with no agglomeration, so there are great market demands and broad application prospects.

Various embodiments in this specification are described in a progressive manner. Each embodiment focuses on the differences from other embodiments. The same or similar parts between various embodiments can be referred to each other.

A method for preparing a highly dispersed ultra-small size carbon-supported noble metal catalyst and a highly dispersed ultra-small size carbon-supported noble metal catalyst provided by the present invention are described in detail above, and specific examples are applied to explain the principle and implementation of the present invention. The above embodiments are only used to help understand the method of the present invention and its core ideas; at the same time, for those skilled in the art, according to the idea of the present invention, there will be changes in the specific implementation and application scope. In summary, the contents of this specification should not be construed as limiting the present invention.

1-9. (canceled)

10. A method for preparing a highly dispersed ultra-small size carbon-supported noble metal catalyst, characterized in, the method comprising:
Step S1: mixing a carbon material with a hydrogenated borophene dispersion, wherein, in a mixed solution, a mass ratio of the carbon material to the hydrogenated borophene is 1:0.01-1; then dispersing the activated carbon in the mixed solution sufficiently and uniformly to obtain a uniform carbon material-supported hydrogenated borophene dispersion;
Step S2: adding an aqueous solution of a noble metal precursor to the uniform carbon material-supported hydrogenated borophene dispersion according to a mass ratio of the carbon material to the noble metal of 1:0.001-0.5, and fully stirring to obtain a suspension of an ultra-small size carbon material-supported noble metal particle catalyst;
Step S3: filtering the suspension to obtain a catalyst powder, and then thoroughly washing the catalyst powder to remove soluble impurities, and finally filtering and drying the powder after washing to obtain a highly dispersed ultra-small size carbon-supported noble metal catalyst.

11. The method according to claim 10, characterized in, the carbon material is one or more selected from the group consisting of carbon black, activated carbon, graphene, graphene oxide, graphdiyne, carbon nanotubes, carbon nanofibers, carbon nanospheres, natural graphite and porous carbon.

12. The method according to claim 10, characterized in, a solvent used in the hydrogenated borophene dispersion is one or more selected from the group consisting of methanol, ethanol, acetone, tetrahydrofuran, and N, N-dimethylformamide.

13. The method according to claim 10, characterized in, the hydrogenated borophene dispersion has a mass concentration of 0.01-20 mg/mL.

14. The method according to claim 12, characterized in, the hydrogenated borophene dispersion has a mass concentration of 0.01-20 mg/mL.

15. The method according to claim 10, characterized in, the step of dispersing the activated carbon in the mixed solution sufficiently and uniformly comprising: using magnetic stirring and ultrasonic dispersion to disperse the activated carbon in the mixed solution sufficiently and uniformly.

16. The method according to claim 10, characterized in, the aqueous solution of the noble metal precursor is a soluble noble metal acid solution or a soluble noble metal salt solution.

17. The method according to claim 16, characterized in, the soluble noble metal acid solution is one or more selected from the group consisting of chloroplatinic acid, chloroauric acid, chloropalladic acid, potassium hexachlororuthenate, chloroiridic acid and chlororhodic acid solution.

18. The method according to claim 10, characterized in, a concentration of the aqueous solution of the noble metal precursor is 1-200 mmol/L.

19. The method according to claim 16, characterized in, a concentration of the aqueous solution of the noble metal precursor is 1-200 mmol/L.

20. A highly dispersed ultra-small size carbon-supported noble metal catalyst, characterized in, the highly dispersed ultra-small size carbon-supported noble metal catalyst is prepared by the method according to claim 10, in the highly dispersed ultra-small size carbon-supported noble metal catalyst, the noble metal particles have a diameter of 0.5-5 nm.

21. A highly dispersed ultra-small size carbon-supported noble metal catalyst, characterized in, the highly dispersed ultra-small size carbon-supported noble metal catalyst is prepared by the method according to claim 11, in the highly dispersed ultra-small size carbon-supported noble metal catalyst, the noble metal particles have a diameter of 0.5-5 nm.

22. A highly dispersed ultra-small size carbon-supported noble metal catalyst, characterized in, the highly dispersed ultra-small size carbon-supported noble metal catalyst is prepared by the method according to claim 12, in the highly dispersed ultra-small size carbon-supported noble metal catalyst, the noble metal particles have a diameter of 0.5-5 nm.

23. A highly dispersed ultra-small size carbon-supported noble metal catalyst, characterized in, the highly dispersed ultra-small size carbon-supported noble metal catalyst is prepared by the method according to claim 13, in the highly dispersed ultra-small size carbon-supported noble metal catalyst, the noble metal particles have a diameter of 0.5-5 nm.

24. A highly dispersed ultra-small size carbon-supported noble metal catalyst, characterized in, the highly dispersed ultra-small size carbon-supported noble metal catalyst is prepared by the method according to claim 14, in the highly dispersed ultra-small size carbon-supported noble metal catalyst, the noble metal particles have a diameter of 0.5-5 nm.

25. A highly dispersed ultra-small size carbon-supported noble metal catalyst, characterized in, the highly dispersed ultra-small size carbon-supported noble metal catalyst is prepared by the method according to claim 15, in the highly dispersed ultra-small size carbon-supported noble metal catalyst, the noble metal particles have a diameter of 0.5-5 nm.

26. A highly dispersed ultra-small size carbon-supported noble metal catalyst, characterized in, the highly dispersed ultra-small size carbon-supported noble metal catalyst is prepared by the method according to claim 16, in the highly dispersed ultra-small size carbon-supported noble metal catalyst, the noble metal particles have a diameter of 0.5-5 nm.

27. A highly dispersed ultra-small size carbon-supported noble metal catalyst, characterized in, the highly dispersed ultra-small size carbon-supported noble metal catalyst is prepared by the method according to claim 17, in the highly dispersed ultra-small size carbon-supported noble metal catalyst, the noble metal particles have a diameter of 0.5-5 nm.

28. A highly dispersed ultra-small size carbon-supported noble metal catalyst, characterized in, the highly dispersed ultra-small size carbon-supported noble metal catalyst is prepared by the method according to claim 18, in the highly dispersed ultra-small size carbon-supported noble metal catalyst, the noble metal particles have a diameter of 0.5-5 nm.

29. A highly dispersed ultra-small size carbon-supported noble metal catalyst, characterized in, the highly dispersed ultra-small size carbon-supported noble metal catalyst is prepared by the method according to claim 10, in the highly dispersed ultra-small size carbon-supported noble metal catalyst, the noble metal particles have a diameter of 0.5-5 nm.
